(19) United States
(12) Patent Application Publication
(10) Pub. No.: US 2021/0405322 A1
(43) Pub. Date: Dec. 30, 2021

(54) DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: MIN ZHENG, WUHAN (CN); MUGYEOM KIM, WUHAN (CN); YONG ZHAO, WUHAN (CN)

(73) Assignee: Wuhan China Star Optoelectronics Semiconductor Display Technology Co., Ltd., Wuhun (CN)

(21) Appl. No.: 16/487,540

(22) PCT Filed: Apr. 19, 2019
(86) PCT No.: PCT/CN2019/083392

§ 371 Date: Aug. 21, 2019

(30) Foreign Application Priority Data
Feb. 26, 2019 (CN) 201910143329.6

(51) Int. Cl. G02B 13/00; G02B 3/02; G02B 7/02

(52) U.S. Cl. CPC G02B 13/001; G02B 2003/0093; G02B 7/021; G02B 3/02

(57) ABSTRACT

A display device includes a display panel having a light-transmitting zone; and a camera module including a lens assembly and an image sensor. The camera module is disposed below the display panel and corresponds to the light-transmitting zone. The lens assembly is disposed between the image sensor and a bottom side of the display panel, and the lens assembly has at least one lens, and at least one lens of the lens assembly is a plano-convex lens. It is provided to thin the lens within the prior camera module, and to arrange the lens in the lens assembly. That is able to effectively reduce a thickness of the lens assembly, and eventually make the camera module occupy a smaller space.

### FIELD OF INVENTION

The present invention relates to the field of liquid crystal display techniques. In particular, the present invention relates to a display device.

### BACKGROUND OF INVENTION

Since current mobile phones tend to be light-thin, deformable and full-screen, one way to have a full screen is to hide a camera module within a panel. In order to ensure that the camera module is able to receive more light, there is a high requirement for transmittance of the stack of the panel.

Because of emergence of a screen concept, requirements corresponding high requirements have also arisen with development of technology. The camera module within a current display device consists of convex lenses. Due to a large thickness of the convex lens, the camera module within the display device occupies a larger space.

### Technical Problem

An object of the present invention is to thin the convex lens within a lens assembly, thereby solving a problem that the camera module occupies the large space of the display device.

### SUMMARY OF INVENTION

The present invention provides a display device. The display device includes a display panel having a light-transmitting zone; and a camera module including a lens assembly and an image sensor, wherein the camera module is disposed below the display panel and corresponds to the light-transmitting zone; and the lens assembly disposed between the image sensor and a bottom side of the display panel, wherein the lens assembly has at least one lens, and at least one lens of the lens assembly is a plano-convex lens.

Furthermore, the lens assembly includes a first plano-convex lens with a first light-in surface being a flat surface toward the light-transmitting zone and a first light-out surface being a curved surface toward the image sensor.

Furthermore, the lens assembly also includes at least one first convex lens disposed between the first plano-convex lens and the image sensor.

Furthermore, the lens assembly includes a second plano-convex lens with a second light-in surface being a curved surface toward the light-transmitting zone and a second light-out surface being a flat surface toward the image sensor.

Furthermore, the lens assembly also includes at least one second convex lens disposed between the second plano-convex lens and the display panel.

Furthermore, the lens assembly includes a third plano-convex lens with a third light-in surface being a flat surface toward the light-transmitting zone as well as a third light-out surface being a curved surface toward the image sensor; and a fourth plano-convex lens with a fourth light-in surface being a curved surface toward the third plano-convex lens as well as a fourth light-out surface being a flat surface toward the image sensor.

Furthermore, the lens assembly also includes at least one third convex lens disposed between the third plano-convex lens and the fourth plano-convex lens.

Moreover, the image sensor has a light-receiving zone which the light transmitted from the lens assembly completely enters.

Moreover, the display panel includes a transparent substrate, wherein the lens assembly is located on the bottom side of the transparent substrate; an array substrate disposed on the transparent substrate layer and having a display zone with sub-pixel areas and non-pixel areas located between the sub-pixel areas; a slot running through the array substrate, wherein the slot corresponding to the light-transmitting zone is filled with transparent material; a thin film encapsulation layer disposed on the array substrate; and a glass cover covering on the thin film encapsulation layer.

Moreover, a thickness of the lens assembly is 0.5 to 5 mm.

### Advantageous Effects

The present invention provides a display device to replace at least one convex lens with the plano-convex lens which is half as thick as the convex lens to reduce the overall thickness of the camera module. Thus, a space below the display device enables to meet the installation of the camera module with reduced thickness, and it is effective to solve a problem that the current camera module occupies the large space of the display device. Moreover, a number of the convex lenses is saved; that is, one convex lens can be cut into two plano-convex lenses for further saving material and cost.

### DESCRIPTION OF DRAWINGS

In order to more clearly illustrate technical solutions in embodiments of the present invention, the drawings required for using in the description of the embodiments will be briefly described below. Obviously, the drawings in the following description are only some of the embodiments of the invention. For ordinary technicians in the art, other drawings may also be obtained from these drawings without paying for creative labor.

FIG. 1 is a schematically structural view of a display device in a first embodiment;

FIG. 2 is a schematically structural view of a camera module in the first embodiment;

FIG. 3 is a schematically structural view of a lens assembly in a second embodiment;

FIG. 4 is a schematically structural view of the display device in a third embodiment; and

FIG. 5 is a schematically structural view of the refraction of light of the lens assembly in the third embodiment.

### DETAILED DESCRIPTION OF PREFERRED EMBODIMENTS

Referring to the accompanying drawings, the description of following embodiments is provided to illustrate the specific embodiment practiced by the present invention. Directional terms described by the present invention, such as upper, lower, front, back, left, right, inner, outer, side, and etc., are only directions by referring to the accompanying drawings. Terms of elements mentioned in the present invention, such as first, second, and etc., are only distinguishing between different parts and can be preferably expressed. In the drawings, structurally similar units are denoted by the same reference numerals.

The embodiments of the present invention will be described in detail herein with reference to the drawings. The present invention may be represented in many different forms and should not be only construed as being limited to the specific embodiments illustrated herein. The embodiments of the present invention are provided to be construed as the practical application of the present invention, and thereby technicians in the art can understand various embodiments of the present invention and various modifications suitable for the particularly expected application.

### The First Embodiment

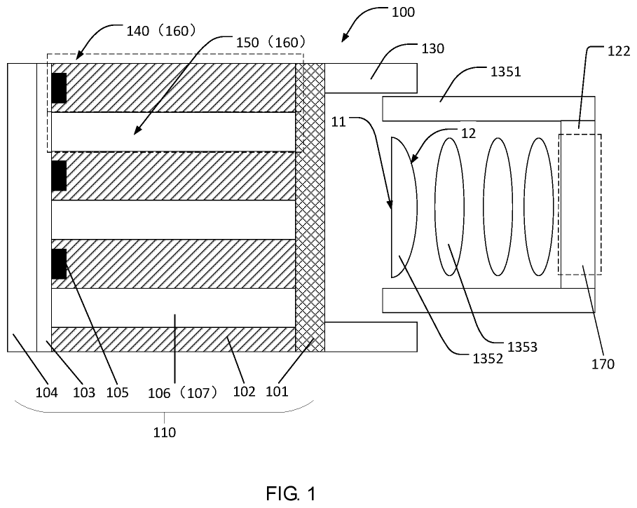

As shown in FIG. 1, in a first embodiment, it provides a display device 100 including a display panel 110, a camera module 120, a frame and a back plate 140.

The display panel includes a transparent substrate 101, an array substrate 102, a thin film encapsulation layer 103 and a glass cover 104.

Material of the transparent substrate 101 includes, but is not limited to, polyimide, diphenylene ether resin or polyethylene naphthalate. The present invention is mainly to form a transparent film layer by coating the polyimide on a rigid load to be the transparent substrate 101. The transparent substrate 101 has a higher stretchability to serve as the material for manufacturing the flexible display panel 110. The rigid load is generally detached after the flexible display panel 110 manufactured.

The array substrate 102 is disposed on the transparent substrate 101 and has a display zone 160 with sub-pixel areas 140 and non-pixel areas 150 located between the sub-pixel areas 140.

The array substrate 102 includes a thin film transistor and an organic light emitting layer 105. The thin film transistor is a low-temperature polysilicon thin film transistor (LTPS-TFT), the thin film transistor (TFT) or an oxide thin film transistor. The thin film transistor can be used to drive the organic light emitting layer 105 to emit light, and the organic light emitting layer 105 can emit red, blue or green light. Each of sub-pixel areas 140 corresponding to the organic light emitting layer 105 can emit the monochromatic light.

There is a slot 106 is disposed on the array substrate 102. The slot 106 runs through the array substrate 102 and is located at the non-pixel zone 150. The slot 106 at the non-pixel zone 150 forms a light-transmitting zone 107 and is filled with organic material at the light-transmitting zone 107. The organic material is transparent material.

The light can be propagated to the camera module 120 through the light-transmitting zone 107 and the transparent substrate 101. The light is converted into an electrical signal by the camera module 120. The camera module 120 transmits the electrical signal to a subsequent processor to generate an image displayed on the flexible display panel 110.

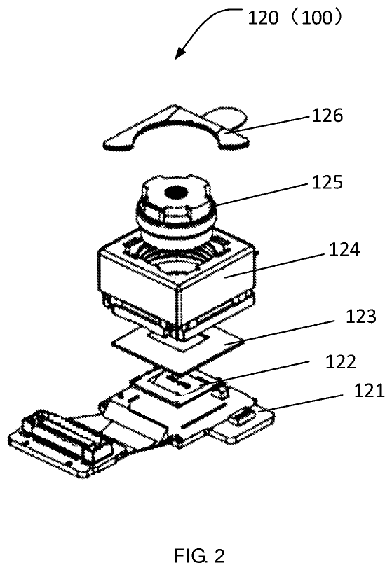

In order to more clearly illustrate a structure of the camera module 120, the camera module 120 combined with FIG. 2 will be described below in detail.

As shown in FIG. 2, in the embodiment, the camera module 120 is disposed below the display panel 110. Specifically, the camera module 120 includes a circuit board 121, an image sensor 122, an infrared filter 123, a focus motor 124, a lens assembly 125 and a protective film 126. The image sensor 122 disposed on the circuit board 121 transmits the received signal to the display device 100 for displaying. The image sensor 122 has a light-receiving zone 170 which the light transmitted from the lens assembly 125 completely enters. The infrared filter 123 is disposed on the image sensor 122. The focus motor 124 is electrically connected to the circuit board 121 and is used to focus on the lens assembly 125. The protective film 126 is disposed on the lens assembly 125 to protect the entire camera module 120.

In the embodiment, the main improvement is to dispose the camera module 120 below the display panel 110. However, a space below the display panel 110 in the display device is limited. Thus, in the embodiment, it is necessary to reduce a thickness of the camera module 120 to meet the requirement of the installation space.

Therefore, in the embodiment, the thickness of the lens assembly 125 is reduced. Specifically, the lens assembly 125 is located at a bottom side of the transparent substrate 101 and is disposed between the image sensor 122 and a bottom side of the display panel 110 as well as corresponds to the light-transmitting zone 107.

Wherein the camera module 125 has at least one lens being a plano-convex lens. The thickness of the camera module 125 varies with a number of the lenses, and is 0.5 to 5 mm. The present invention reduces the space occupied by the lens assembly for the display device by thinning the lens to reduce the thickness of the lens assembly.

In the first embodiment, the lens assembly 125 includes a first plano-convex lens 1352, at least one first convex lens 1353 and a lens housing 1351. Wherein a number of the first convex lens 1353 is three, and may be one, two, or four.

The first plano-convex lens 1352 has a first light-in surface 11 being a flat surface toward the light-transmitting zone 107 and a first light-out surface 12 being a curved surface toward the image sensor 122. The first convex lens 1353 is disposed between the first plano-convex lens 1352 and the image sensor 122.

The lens group is placed in the lens housing 1351, and the lens housing 1351 is used to protect the lens.

When the light is refracted in the lens assembly 1351 through the light-transmitting zone, it can be more centrally transmitted to the image sensor 122, and eventually images captured by a real device can be clearer.

The back plate 130 is disposed on a back of the display device 100, and surrounds the lens assembly 125.

The frame is disposed on sides of the display device 100, and protects the display device 100 together with the back plate 130 and the protective glass.

The thin film encapsulation layer 103 is disposed on the array substrate 102. The manufacturing method of the thin film encapsulation layer 103 can be a chemical vapor deposition, an atomic layer deposition method and an inkjet printing method, and wherein the present invention is preferably the chemical vapor deposition method. The thin film encapsulation layer 103 mainly functions as insulating from water and oxygen so as to protect the related display parts on the array substrate 102.

The glass cover 104 covering on the thin film encapsulation layer 103 is a protective glass layer to protect the display device 100.

### The Second Embodiment

In order to reduce the thickness of the camera module to meet the requirement of the installation space and simultaneously meet different focusing designs, it is also possible to adopt following methods to reduce the entire thickness of the lens assembly 125.

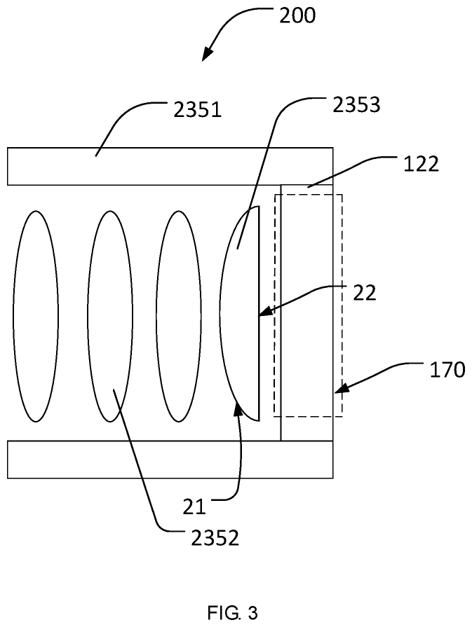

In the second embodiment, as shown in FIG. 3, the lens assembly includes a second plano-convex lens 2353, at least one second convex lens 2352 and a lens housing 2351. Wherein a number of the second convex lens 2353 is three, and may be one, two, or four.

The second plano-convex lens 2353 has a second light-in surface 21 being a curved surface toward the light-transmitting zone 107 and a second light-out surface 22 being a flat surface toward the image sensor 122.

The second embodiment with respect to the first embodiment substantially has identical structures except for the different structure of the camera module. Therefore, it is no longer to describe the structures or components except for the lens assembly in detail, and those can be referred to the first embodiment.

The difference between the second embodiment and the first embodiment is that a position of the second plano-convex lens 2353 is adjusted to a side of the lens assembly close to the image sensor 122.

The second embodiment places the second convex lens 2352 on a side close to the display panel. Because the plano-convex lens of the same length is smooth with respect to a surface of the convex lens, its received light is weakened. Therefore, there is a better effect for the refraction of light to place the second convex lens 2352 on the side close to the display panel.

### The Third Embodiment

In order to further thin the camera module 120, it is also possible to adopt following methods to thin the thickness of the lens of the lens assembly close to the image sensor 122. That is described in the third embodiment.

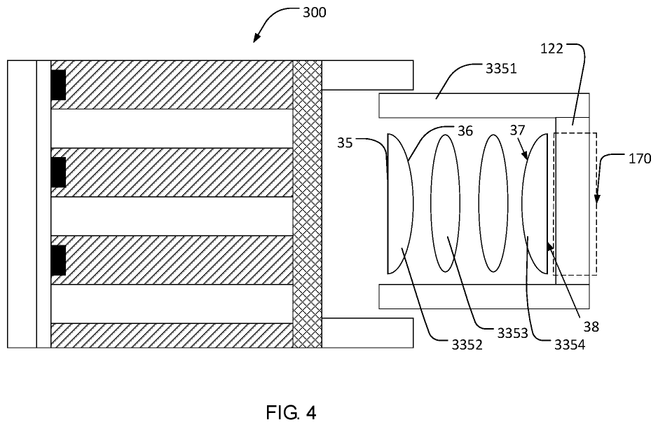

As shown in FIG. 4, in the third embodiment, the lens assembly includes a third plano-convex lens 3352, a fourth plano-convex lens 3354, at least one third convex lens 3353 and a lens housing 3351. Wherein a number of the third convex lens 3352 is two, and may be one, three, or four.

The third plano-convex lens 3352 has a third light-in surface 35 being a flat surface toward the light-transmitting zone as well as a third light-out surface 36 being a curved surface toward the image sensor 122; and the fourth plano-convex lens 3354 with a fourth light-in surface 37 being a curved surface toward the third plano-convex lens as well as a fourth light-out surface 38 being a flat surface toward the image sensor. The third convex lens 3353 is disposed between the third plano-convex lens 3352 and the fourth plano-convex lens 3354.

In the third embodiment with respect to the first embodiment, the lenses being at both sides of the lens assembly are placed between the third plano-convex lens 3352 and the fourth plano-convex lens by a polishing technology.

The third embodiment with respect to the first embodiment substantially has identical structures except for the different structure of the camera module. Therefore, it is no longer to describe the structures or components except for the lens assembly in detail, and those can be referred to the first embodiment.

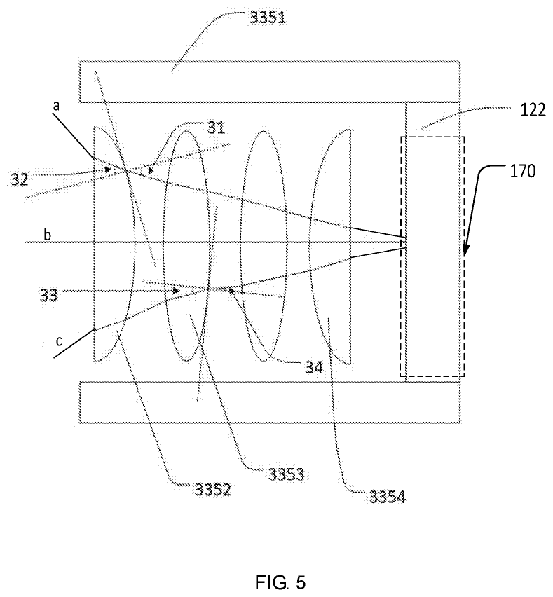

As shown in FIG. 5, incident rays a, b, c are first refracted through the plano-convex lens, wherein an angle of incidence 32>an angle of emergence 31, and then they are refracted through the convex lens for a second time, wherein an angle of incidence 33>an angle of emergence 34, and finally the light can be densely transmitted to the image sensor 122. After the image signal processing, the image sensor 122 transmits the signal to the display device 300 for related applications.

The third embodiment is the most preferable embodiment in the present invention. By forming a semi-convex lens by thinning the lenses at both sides of the lens assembly, the thickness of the camera module 120 can be further reduced, and finally the space occupied by the camera module 120 can be reduced. Moreover, a convex lens can be cut into two plano-convex lenses for saving material and cost.

The technical scope of the present invention is not only limited to the content of the description. The technicians in the art can make various modifications and alterations to the embodiments without departing from the technical spirit of the present invention, and all of the modifications and alterations are within the scope of the present invention.

What is claimed is:

1. A display device, comprising:
a display panel having a light-transmitting zone; and
a camera module including a lens assembly and an image sensor, wherein the camera module is disposed below the display panel and corresponds to the light-transmitting zone; and the lens assembly disposed between the image sensor and a bottom side of the display panel, wherein the lens assembly has at least one lens, and at least one lens of the lens assembly is a plano-convex lens.

2. The display device according to claim 1, wherein the lens assembly comprises a first plano-convex lens with a first light-in surface being a flat surface toward the light-transmitting zone and a first light-out surface being a curved surface toward the image sensor.

3. The display device according to claim 2, wherein the lens assembly also comprises at least one first convex lens disposed between the first plano-convex lens and the image sensor.

4. The display device according to claim 1, wherein the lens assembly comprises a second plano-convex lens with a second light-in surface being a curved surface toward the light-transmitting zone and a second light-out surface being a flat surface toward the image sensor.

5. The display device according to claim 4, wherein the lens assembly also comprises at least one second convex lens disposed between the second plano-convex lens and the display panel.

6. The display device according to claim 1, wherein the lens assembly comprises a third plano-convex lens with a third light-in surface being a flat surface toward the light-transmitting zone as well as a third light-out surface being a curved surface toward the image sensor; and a fourth plano-convex lens with a fourth light-in surface being a curved surface toward the third plano-convex lens as well as a fourth light-out surface being a flat surface toward the image sensor.

7. The display device according to claim 6, wherein the lens assembly also comprises at least one third convex lens disposed between the third plano-convex lens and the fourth plano-convex lens.

8. The display device according to claim 1, wherein the image sensor has a light-receiving zone which the light transmitted from the lens assembly completely enters.

9. The display device according to claim 1, wherein the display panel comprises:
a transparent substrate, wherein the lens assembly is located on the bottom side of the transparent substrate;
an array substrate disposed on the transparent substrate layer and having a display zone with sub-pixel areas and non-pixel areas located between the sub-pixel areas;
a slot running through the array substrate, wherein the slot corresponding to the light-transmitting zone is filled with transparent material;
a thin film encapsulation layer disposed on the array substrate; and
a glass cover covering on the thin film encapsulation layer.

10. The display device according to claim 1, wherein a thickness of the lens assembly is 0.5 to 5 mm.
